(19) United States
(12) Patent Application Publication
(10) Pub. No.: US 2012/0201599 A1
(43) Pub. Date: Aug. 9, 2012

(54) Shackle

(76) Inventor: David Reppen, Toronto (CA)

(21) Appl. No.: 13/194,919

(22) Filed: Jul. 30, 2011

(30) Foreign Application Priority Data
Feb. 4, 2011 (CA) 2730602

(51) Int. Cl. F16G 15/06

(52) U.S. Cl. 403/348

(57) ABSTRACT

There is disclosed a shackle for securing objects. The shackle includes a substantially U shaped member having opposite first and second ends, said first and second ends having threaded first and second apertures. The U shaped member is configured such that the first and second threaded apertures are co-axially aligned. The first and second threaded apertures have substantially identical diameters and substantially identical thread patterns. The shackle further includes a cylindrical pin having opposite first and second ends, a cross sectional diameter and a length, the first end of the pin having a first threaded portion, the cross sectional diameter of the pin and the threaded portion being configured such that the pin can be threaded into both the first and second threaded apertures of the U shaped member. Finally, a handle is formed on the second end of the pin and the length of the pin is selected such that the pin can span both the first and second threaded apertures.

### FIELD OF THE INVENTION

The invention relates generally to shackles.

### BACKGROUND OF THE INVENTION

Shackles and U bolts are often used in various industry, including the entertainment industry. These shackles are generally used to secure heavy objects to a harness or support. Most U bolt type shackles consist of a U shaped member having opposite ends, with apertures formed on each of the opposite ends of the U shaped member. The apertures are coaxially aligned and a long pin is provided which is configured to pass into apertures to close off the U bolt shackle. One of the apertures is often provided with threading and the pin is generally provided with corresponding threading to permit the pin to be threaded into the shackle. It will be appreciated that it is necessary to disengage the pin with the U shaped member in order to attach the shackle. This requires the pin to be placed in a pocket for storage until the shackle is to be closed. It will be appreciated that in situations where an individual is using a plurality of such shackles, there is always the possibility that a pin may accidently be dropped when the user attempts to thread the pin into the shackle to close the shackle or when the shackle is being opened. If the user is attempting to secure a suspended object, dropping the pin may injure someone standing below. An improved shackle which makes it less likely for the pin to be accidentally dropped is therefore required.

### SUMMARY OF THE INVENTION

In accordance with one aspect of the present invention, there is provided a shackle for securing objects. The shackle includes a substantially U shaped member having opposite first and second ends, said first and second ends having threaded first and second apertures. The U shaped member is configured such that the first and second threaded apertures are co-axially aligned. The first and second threaded apertures have substantially identical diameters and substantially identical thread patterns. The shackle further includes a cylindrical pin having opposite first and second ends, a cross sectional diameter and a length, the first end of the pin having a first threaded portion, the cross sectional diameter of the pin and the threaded portion being configured such that the pin can be threaded into both the first and second threaded apertures of the U shaped member. Finally, a handle is formed on the second end of the pin and the length of the pin is selected such that the pin can span both the first and second threaded apertures.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1 is a side view of a shackle made in accordance with the invention.

FIG. 2 is a sectional view of the shackle shown in FIG. 1.

FIG. 3 is a front view of a shackle made in accordance with the invention without the pin portion.

FIG. 4 is a back view of the shackle shown in FIG. 3.

FIG. 5 is a side view of the pin portion of a shackle made in accordance with the present invention.

FIG. 6 is perspective view of a shackle made in accordance with the present invention showing the pin in its fully inserted position.

FIG. 7 is a perspective view of the shackle shown in FIG. 6 showing the pin partially removed.

In the drawings like characters of reference indicate corresponding parts in the different figures.

### DETAILED DESCRIPTION OF THE INVENTION

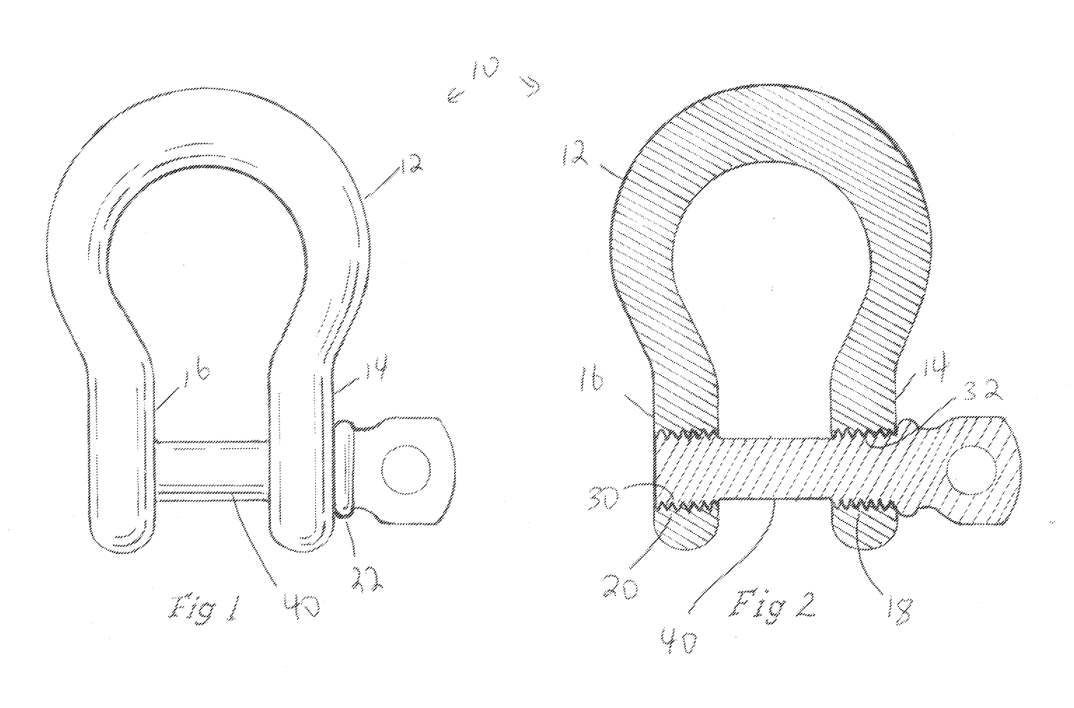

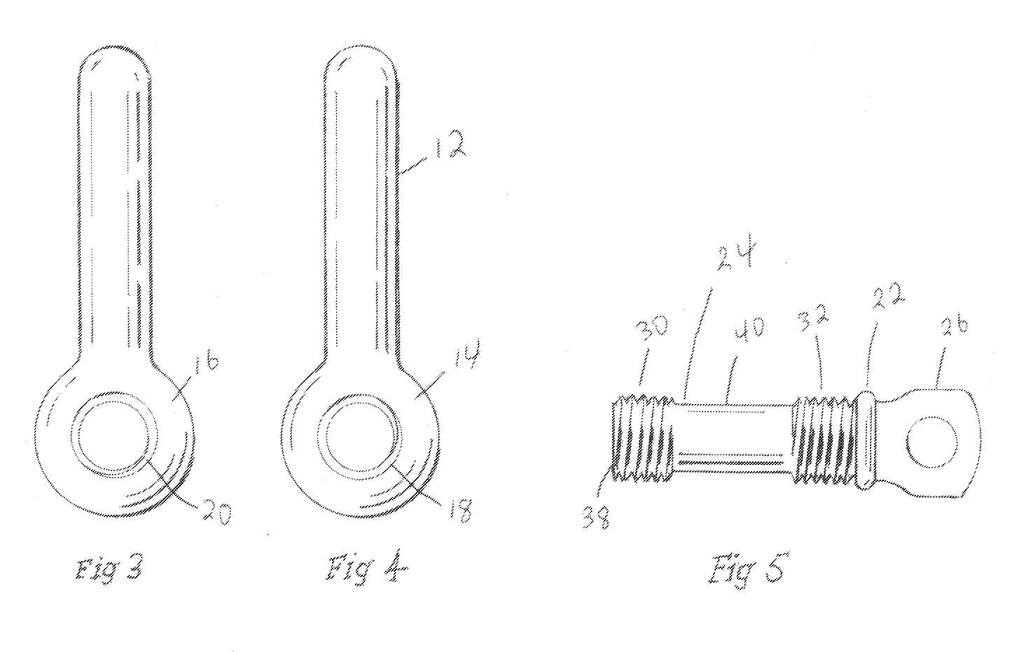

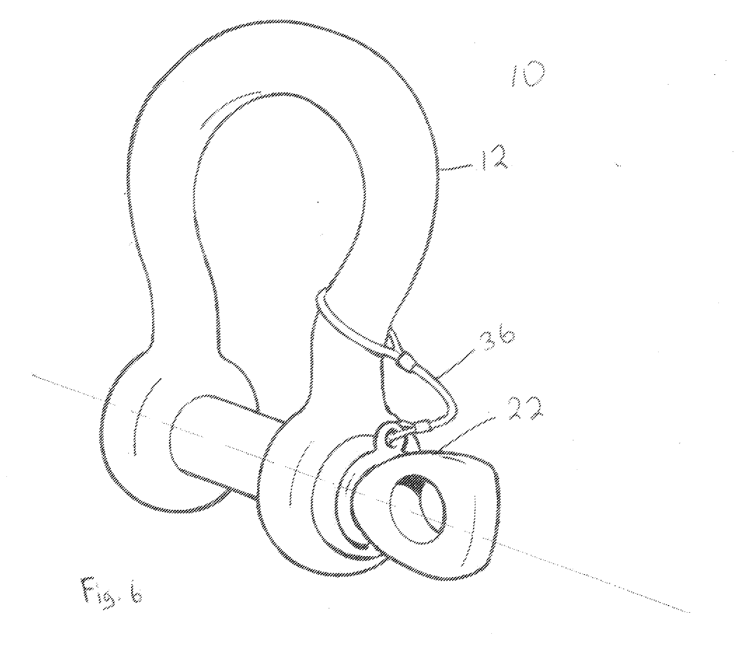

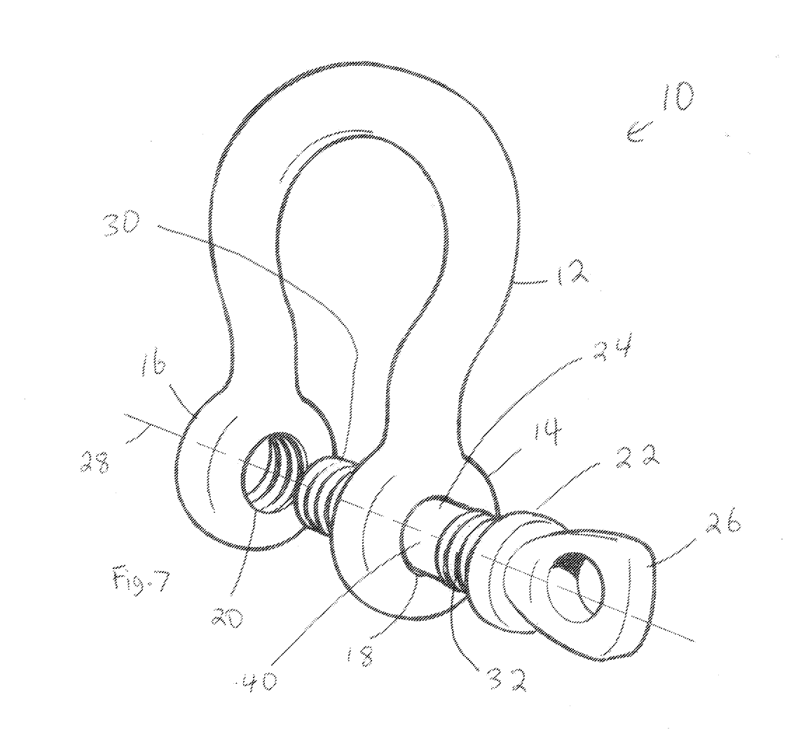

Referring firstly to FIG. 7, a shackle made in accordance with the present invention, shown generally as item 10, includes a generally U shaped member 12 which is typically made of steel. U shaped member 12 is generally in the form of a U (or a horse shoe) and consists of an elongated bar of steel having a roughly cylindrical cross section and opposite ends 14 and 16. Ends 14 and 16 are somewhat flattened to accommodate threaded apertures 18 and 20. Apertures 18 and 20 are aligned with axis 28. Pin 22 is an elongated steel cylinder 24 having a length sufficient to span apertures 18 and 20. Pin 22 is provided with a handle portion 26 at one end to make it easier to grasp and rotate the pin. Pin 22 has threaded portions 30 and 32 which are configured to mesh with threaded apertures 20 and 18, respectively. Non-threaded portion 40 separates threaded portions 30 and 32. Preferably, the lengths of the threaded and non-threaded portions of pin 22 are configures such that the non-threaded portion extends between ends 14 and 16 when the pin is fully inserted into the U shaped member 12 as seen in FIGS. 6 and 2.

As best seen in FIG. 5, pin 22 has threaded portion 30 located at end 38 of shaft 24. Threaded portion 32 is positioned adjacent handle portion 26 and non-threaded portion 40 extends between both threaded portions. The non-threaded portion between the two threaded portions permits less ware to a chain or rope (not shown) which may bear against shaft 24.

As better shown in FIGS. 1 and 2, pin 22 spans the gap separating ends 16 and 14 and provides a means for closing shackle 10. Threaded portions 20 and 32 are precisely threaded to carefully thread with apertures 18 and 20, respectively, to permit a strong connection between the pin and the U shaped member.

As better seen in FIG. 6, shackle 10 may be provided with a lanyard 36 which joins pin 22 to U shaped member 12. The lanyard permits pin 22 to be completely removed from the U shaped member without causing the pin to be moved too far away from the U shaped member. This decreases the likelihood of loosing or dropping the pin. However, it will be appreciated that in order to permit shackle 10 to function properly, lanyard 36 must be sufficiently long to permit pin 22 to be completely removed from U shaped member 12.

Returning back to FIG. 7, the advantage of the present shackle can be seen. Since pin 22 is threaded at two portions on shaft 24 and since apertures 18 and 20 are both threaded, it is possible to put pin 22 in a position where both threaded portions 30 and 32 are disengaged, but the pin is still mounted to U shaped member 12. Since aperture 18 is threaded, threaded portion 30 prevents pin 22 from accidentally slipping out of aperture 18 and drop to the floor. The shackle, placed in the position illustrated in FIG. 7, is partially opened, and can be used to pass a rope or chain between ends 14 and 16, even though pin 22 is still partially retained in the shackle. This makes it possible to mount the shackle as required without having to completely remove the pin. To completely remove the pin, pin 22 is further rotated such that threaded portion 30 passes all the way past threaded opening 18.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

1. A shackle comprising:
a substantially U shaped member having opposite first and second ends, said first and second ends having threaded first and second apertures, the U shaped member being configured such that the first and second threaded apertures are co-axially aligned;
the first and second threaded apertures having substantially identical diameters and substantially identical thread patterns;
a cylindrical pin having opposite first and second ends, a cross sectional diameter and a length, the first end of the pin having a first threaded portion, the cross sectional diameter of the pin and the threaded portion being configured such that the pin can be threaded into both the first and second threaded apertures of the U shaped member;
a handle formed on the second end of the pin, the length of the pin being selected such that the pin can span both the first and second threaded apertures.

2. The shackle as defined in claim 1 wherein the pin has a second threaded portion positioned between the first and second ends of the pin and adjacent the handle portion, the second threaded portion configured to thread with both the first and second threaded aperture, the pin having a non-threaded portion separating the first and second threaded portions.

3. The shackle as defined in claim 2 wherein the first and second threaded portions of the pin are dimensioned such that the first and second threaded portions are mated to the first and second threaded apertures when the pin is fully threaded into the shackle and the pin spans the first and second ends of the U shaped member.

4. The shackle as defined in claim 3 wherein the non-threaded portion has a length sufficient to span between the first and second threaded apertures of the U shaped member.
